(19) United States
(12) Patent Application Publication
(10) Pub. No.: US 2006/0045207 A1
(43) Pub. Date: Mar. 2, 2006

(54) Peak detection in mass spectroscopy data analysis

(76) Inventors: Jie Cheng, Princeton, NJ (US); Claus Neubauer, Monmouth Junction, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/180,342

(22) Filed: Jul. 13, 2005

Related U.S. Application Data
(60) Provisional application No. 60/604,299, filed on Aug. 25, 2004.

(51) Int. Cl. H04L 25/06

(52) U.S. Cl. 375/317

(57) ABSTRACT

A computer-implemented method for extracting peak information including providing a data spectrum, normalizing the data spectrum, binning features for reducing the resolution of the data spectrum and filtering noise from a normalized data spectrum, identifying at least one peak in the normalized data spectrum, performing a baseline correction of the at least one peak, and performing data mining on the at least one peak to determine a pathology.

This application claims priority to U.S. Provisional Application Ser. No. 60/604,299, filed on Aug. 25, 2004, which is herein incorporated by reference in its entirety.

### BACKGROUND OF THE INVENTION

1. Technical Field

The present invention relates to data mining, and more particularly to extracting peak information from mass spectra including a combined peak identification and baseline correction.

2. Discussion of Related Art

Protein expression analysis is a new research field in bioinformatics. Different protein expression profiles can be revealed by running tissue or blood serum samples through a mass spectroscopy machine. One important step to discover the protein expression profiles is to successfully extract and align peaks from the noisy mass spectra. The identified peaks can then be studied to identify the bio-marks that can distinguish between different types of samples, such as cancerous and healthy.

Extracting peak information from mass spectra involves several procedures, such as normalization, smoothing, baseline correction, peak identification, and peak alignment. Not all these procedures are needed for every peak detection method. Two different approaches are described in Baggerly et al., “A comprehensive approach to the analysis of matrix-assisted laser desorption/ionization-time of flight proteomics spectra from serum samples,” Proteomics 2003, and Wagner et al., “Protocols for disease classification from mass spectrometry data,” Proteomics 2003. Different combinations may provide improved results and/or greater efficiency.

Therefore, a need exists for a system and method for extracting peak information from mass spectra including a combined peak identification and baseline correction.

### SUMMARY OF THE INVENTION

According to an embodiment of the present disclosure a computer-implemented method for extracting peak information includes providing a data spectrum, normalizing the data spectrum, and binning features for reducing the resolution of the data spectrum and filtering noise from a normalized data spectrum. The method further comprises identifying at least one peak in the normalized data spectrum, performing a baseline correction of the at least one peak, and performing data mining on the at least one peak to determine a pathology.

The method includes aligning the at least one peak between at least two spectra of the normalized data spectrum prior to performing the data mining.

Normalizing comprises normalizing a total ion current of the data spectrum. For each spectrum, an intensity of every point is summed and a relative intensity is determined as an intensity value at each point divided by the sum.

Binning comprises averaging two or more neighboring points.

Identifying the at least one peak comprises a baseline correction. Identifying the at least one peak includes windowing the spectrum, wherein a window of a fixed size is moved through the data spectrum and peaks are identified within the window, and recording, for each peak, a relative intensity, wherein the relative intensity is a difference between a height of a central point and a mean height of a given number of lowest points inside the window.

Aligning the peak includes determining at least one other peak in another spectrum within a mass accuracy of the at least one peak, and defining the at least one peak and the at least one other peak as the same peak.

The data mining determines a biomarker.

According to an embodiment of the present disclosure, a program storage device is provided readable by machine, tangibly embodying a program of instructions executable by the machine to perform method steps for extracting peak information. The method steps include providing a data spectrum, normalizing the data spectrum, and binning features for reducing the resolution of the data spectrum and filtering noise from a normalized data spectrum. The method includes identifying at least one peak in the normalized data spectrum, performing a baseline correction of the at least one peak, and performing data mining on the at least one peak to determine a pathology.

According to an embodiment of the present disclosure, a computer-implemented method for peak detection in data includes providing a data spectrum, and determining a peak in the data spectrum. Determining the peak comprises, windowing the data spectrum comprising moving a window through the data spectrum, determining a center point for each position of a window, and determining whether the center point is a peak. The method further includes determining from the peak an attribute of the data spectrum, and identifying a bio-marker according to an arrangement of the peak in the data spectrum.

Determining whether the center point is a peak comprises determining a relation between the center point and neighboring points within the window.

Determining whether the center point is a peak comprises determining an area under the data spectrum within a certain number of points of the central point. The method includes comparing the area under the data spectrum to a predetermined threshold, wherein if the area under the data spectrum is greater than the threshold the center point is defined as the peak.

The method further includes recording a relative intensity of the peak as a difference between a height of a central point of the peak and a mean height of a certain number of lowest points inside the window.

### BRIEF DESCRIPTION OF THE DRAWINGS

Preferred embodiments of the present disclosure will be described below in more detail, with reference to the accompanying drawings:

FIG. 1 is a method for peak information according to an embodiment of the present disclosure;

FIG. 2 is a diagram of a system according to an embodiment of the present disclosure;

FIG. 3 is a graph of a raw spectra according to an embodiment of the present disclosure;

FIG. 4 is a graph of a spectra after feature binning according to an embodiment of the present disclosure;

FIG. 5 is a graph of the output of peak detection according to an embodiment of the present disclosure;

FIG. 6A is a flow chart of a method for peak detection using a slope of a line in a spectrum according to an embodiment of the present disclosure; and

FIG. 6B is a flow chart of a method for peak detection using an area under a spectrum according to an embodiment of the present disclosure.

### DETAILED DESCRIPTION OF PREFERRED EMBODIMENTS

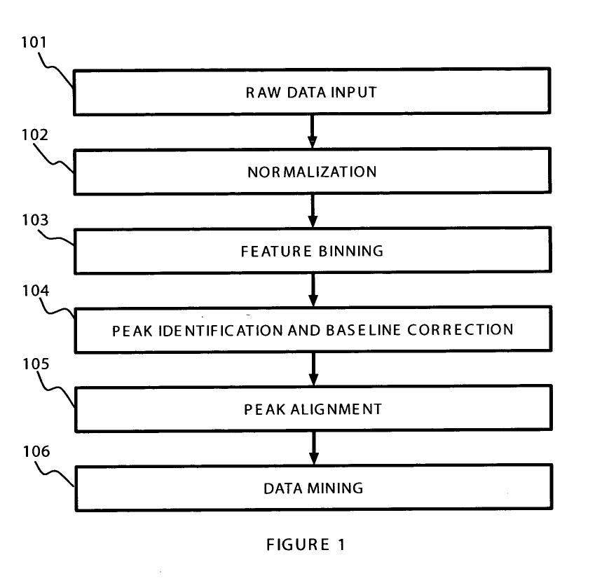

According to an embodiment of the present disclosure, a method for peak detection comprises normalization, feature binning, peak identification and baseline correction, and peak alignment. Referring to FIG. 1, a method for peak detection includes providing raw data spectra 101, the raw data spectra are normalized 102, feature binning reduces the resolution of the spectra and filters noise 103, peaks in the spectra are identified and a baseline correction of the identified peak is determined 104, peak alignment is performed for the same peak in the spectra 105 and data mining can be performed on the identified peaks 106.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

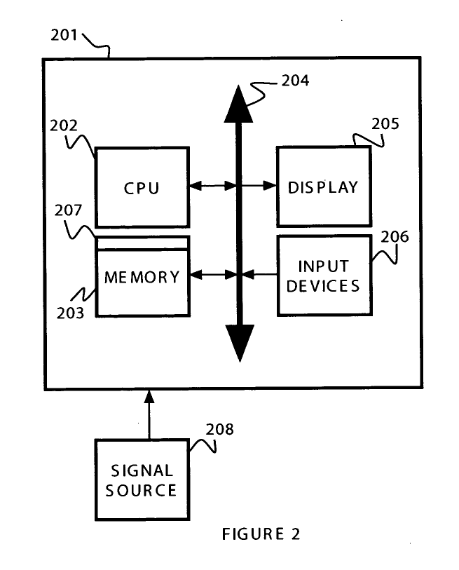

Referring to FIG. 2, according to an embodiment of the present disclosure, a computer system 201 for implementing a method for extracting peak information, inter alia, a central processing unit (CPU) 202, a memory 203 and an input/output (I/O) interface 204. The computer system 201 is generally coupled through the I/O interface 204 to a display 205 and various input devices 206 such as a mouse and keyboard. The display 205 can display views of the virtual volume and registered images. The support circuits can include circuits such as cache, power supplies, clock circuits, and a communications bus. The memory 203 can include random access memory (RAM), read only memory (ROM), disk drive, tape drive, etc., or a combination thereof. The present invention can be implemented as a routine 207 that is stored in memory 203 and executed by the CPU 202 to process the signal from the signal source 208. As such, the computer system 201 is a general purpose computer system that becomes a specific purpose computer system when executing the routine 207 of the present invention.

The computer platform 201 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

For normalization 102, the total ion current is used to normalize the spectra. For each spectrum, the intensity of every point is summed. The relative intensity is determined as the intensity value at each point divided by the sum.

Referring to feature binning 103, the raw data may have too many points in each spectrum. The neighboring points are averaged to lower the resolution and filter local noise.

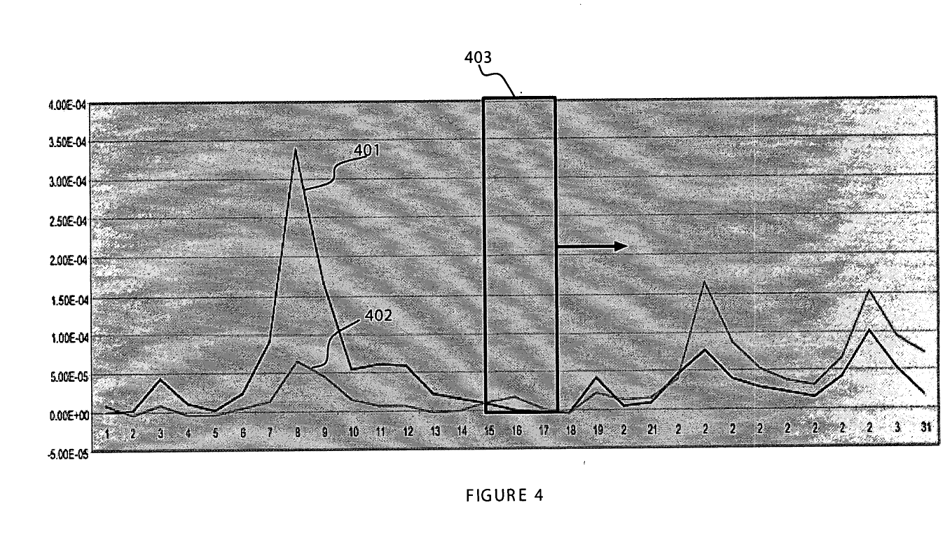

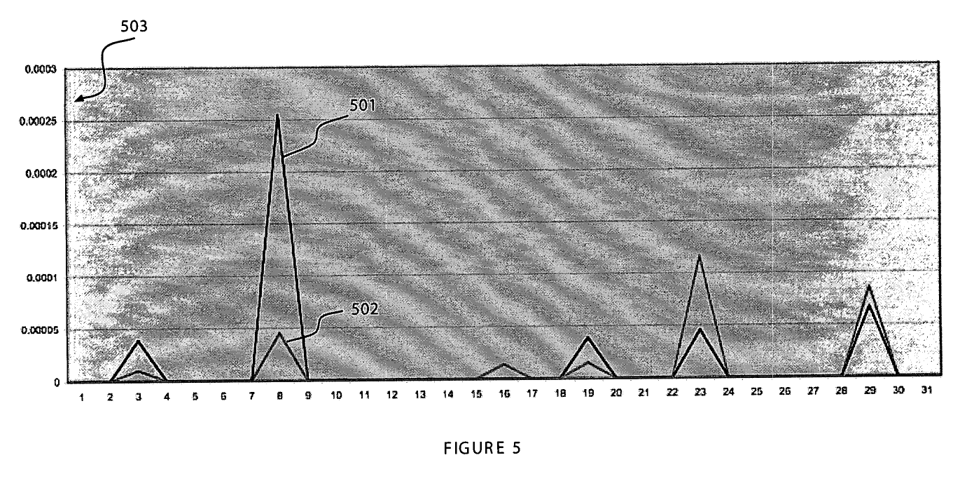

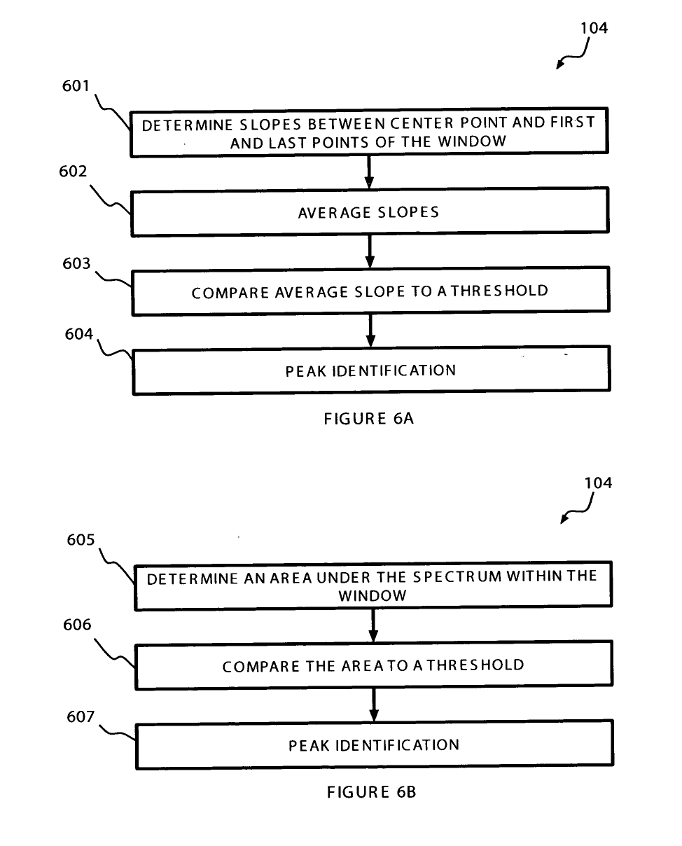

Peak identification and baseline correction 104 are combined into one procedure. The procedure is based on using a fixed size window (see FIG. 4, 403) that slides through a spectrum. The size of the window is set to be larger than the width of a peak, for example, 2 units as shown in FIG. 5. The window size can be specified by a user upon visual inspection of the raw data spectra, wherein the user determines a size larger than an average peak appearing in the raw data spectra. As the window slides through a spectrum, criteria are used to determine whether a central point in the window is a peak. For example, the criteria can be based on the relation between the central point and its neighboring points. The relation may be, for example as shown in FIG. 6A, a slope of a line formed between a first point in the window and the center point or an average slope as between the first point in the window and the center point and between the center point and a last point in the window 601-602. The slopes can be compared to a certain predetermined threshold slope for determining a peak 603. If the average slope is greater than the threshold, then the center point is defined as a peak 604. According to another example of the criteria, the criteria can be based on the area under the spectrum near the central point. Referring to FIG. 6B, in the case where the area under the spectrum is implemented, the area under the data spectrum within the window is determined 605. The area is compared to a certain predetermined threshold area 606, wherein if the area under the data spectra is greater than the threshold the center point is defined as the peak 607. The threshold area may be determined according to the particular spectrum and the size of the window being used. One of ordinary skill in the art would recognize in light of the present disclosure that other criteria can be used to determine a center point as a peak.

Once a peak is detected, a relative intensity of the peak is recorded as a difference between a height of the peak/center point and a mean height of several lowest points inside the window, e.g., 2 points, 20 points, 350 points, etc.

Peak alignment may be needed because the same peak in different spectra series can be out of alignment. Peak alignment can be omitted if different series of the raw data are determined to be well aligned. A peak is identified that is frequently appeared in different spectra and then try to see if there are other peaks within the mass accuracy in other spectra. If there are other peaks, these peaks are considered as the same peak.

The relative heights of the identified peaks are used as input of different data mining methods for disease specific biomarker discovery. Examples of data mining methods include artificial neural networks, decision trees and Bayesian networks. These methods can use the identified peaks and patients' group information (benign or cancerous) as inputs to train classification models. These models can classify patients into different groups (such as benign vs. cancerous) given patients' mass spectroscopy data and a comparison to a data base of known pathologies, e.g., protein expression.

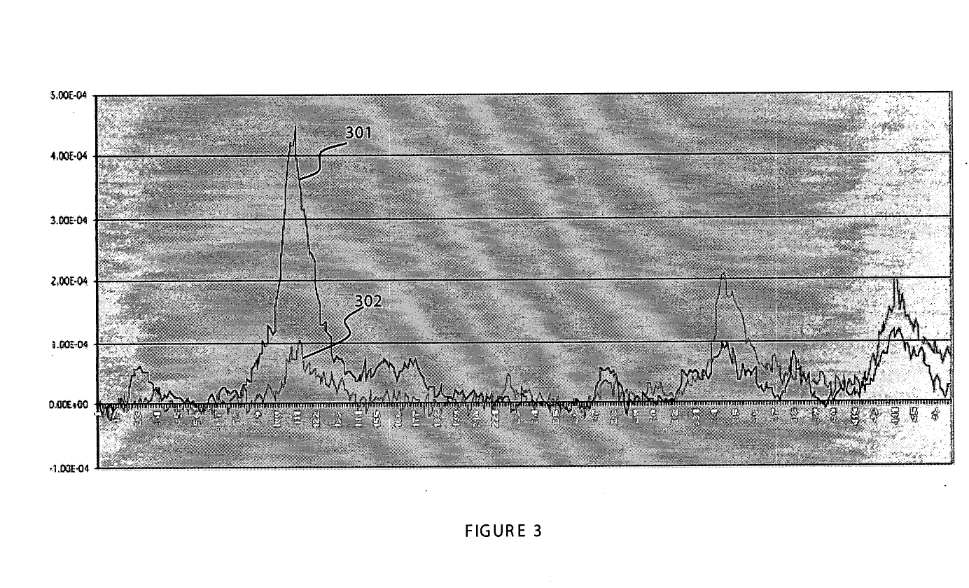

FIG. 3 shows two raw spectra 301 and 302 of a particular mass range. FIG. 4 shows the spectra 301 and 302 after feature binning 103, depicted as 401 and 402. The output of the peak detection method is shown in FIG. 5 as the spectra 501 and 502. The detected peaks are measure on the Y-axis 503. Areas determined not to be peaks have a value of 0 on the Y-axis 503.

Methods described herein may be implemented together with, for example, a protein expression database, a mass spectrophotometer, etc. Therefore, any application in which a pattern of peak values in spectra needs to be identified may be used in conjunction with embodiments of the present disclosure.

Having described embodiments for a system and method for extracting peak information, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A computer-implemented method for extracting peak information comprising:
providing a data spectrum;
normalizing the data spectrum;
binning features for reducing the resolution of the data spectrum and filtering noise from a normalized data spectrum;
identifying at least one peak in the normalized data spectrum;
performing a baseline correction of the at least one peak; and
performing data mining on the at least one peak to determine a pathology.

2. The computer-implemented method of claim 1, further comprising aligning the at least one peak between at least two spectra of the normalized data spectrum prior to performing the data mining.

3. The computer-implemented method of claim 1, wherein normalizing comprises normalizing a total ion current of the data spectrum.

4. The computer-implemented method of claim 3, wherein for each spectrum, an intensity of every point is summed and a relative intensity is determined as an intensity value at each point divided by the sum.

5. The computer-implemented method of claim 1, wherein binning comprises averaging two or more neighboring points.

6. The computer-implemented method of claim 1, wherein identifying the at least one peak comprises a baseline correction.

7. The computer-implemented method of claim 1, wherein identifying the at least one peak comprises:
windowing the spectrum, wherein a window of a fixed size is moved through the data spectrum and peaks are identified within the window; and
recording, for each peak, a relative intensity, wherein the relative intensity is a difference between a height of a central point and a mean height of a given number of lowest points inside the window.

8. The computer-implemented method of claim 2, wherein aligning the peak comprises:
determining at least one other peak in another spectrum within a mass accuracy of the at least one peak; and
defining the at least one peak and the at least one other peak as the same peak.

9. The computer-implemented method of claim 1, wherein the data mining determines a biomarker.

10. A program storage device readable by machine, tangibly embodying a program of instructions executable by the machine to perform method steps for extracting peak information, the method steps comprising:
providing a data spectrum;
normalizing the data spectrum;
binning features for reducing the resolution of the data spectrum and filtering noise from a normalized data spectrum;
identifying at least one peak in the normalized data spectrum;
performing a baseline correction of the at least one peak; and
performing data mining on the at least one peak to determine a pathology.

11. The method of claim 10, further comprising aligning the at least one peak between at least two spectra of the normalized data spectrum prior to performing the data mining.

12. A computer-implemented method for peak detection in data comprising:
providing a data spectrum;
determining a peak in the data spectrum, wherein determining the peak comprises,
windowing the data spectrum comprising moving a window through the data spectrum,
determining a center point for each position of a window, and
determining whether the center point is a peak,
determining from the peak an attribute of the data spectrum; and
identifying a bio-marker according to an arrangement of the peak in the data spectrum.

13. The computer-implemented method of claim 12, wherein determining whether the center point is a peak comprises determining a relation between the center point and neighboring points within the window.

14. The computer-implemented method of claim 12, wherein determining whether the center point is a peak comprises determining an area under the data spectrum within a certain number of points of the central point.

15. The computer-implemented method of claim 14, further comprising comparing the area under the data spectrum to a predetermined threshold, wherein if the area under the data spectrum is greater than the threshold the center point is defined as the peak.

16. The method of claim 12, further comprising recording a relative intensity of the peak as a difference between a height of a central point of the peak and a mean height of a certain number of lowest points inside the window.
